(19) United States
(12) Patent Application Publication
(10) Pub. No.: US 2020/0087224 A1
(43) Pub. Date: Mar. 19, 2020

(54) COMPOSTING APPARATUS USABLE IN AN INDUSTRIAL SCALE AND PROCESS OF USE THEREOF

(71) Applicant: ANACONDA SYSTEMS LIMITED, Vancouver (CA)

(72) Inventor: RUSSELL ZISHIRI, Vancouver, British Columbia (CA)

(21) Appl. No.: 16/341,738

(22) PCT Filed: Oct. 12, 2017
(86) PCT No.: PCT/CA2017/000226

§ 371 Date: Apr. 12, 2019

Related U.S. Application Data
(60) Provisional application No. 62/407,349, filed on Oct. 12, 2016.

(51) Int. Cl. C05F 17/02; B09B 3/00; C05F 9/02; B02C 18/00

(52) U.S. Cl. CPC C05F 17/0258; B09B 3/00; C05F 17/0217; B02C 18/0092; C05F 9/02

(57) ABSTRACT

A system for converting organic waste into compost comprising a preliminary storage/pre-processing unit, an auger-free, composting unit comprising a plurality of top entry portals and at least one bottom exit portal, and an organic waste conveyance means between the preliminary storage/pre-processing unit and the auger-free, composting unit.

### FIELD OF THE INVENTION

This invention relates to a method and apparatus for composting organic waste, and more specifically to a method and apparatus for recycling and/or converting waste organic products into usable compost.

### BACKGROUND OF THE INVENTION

The growth of organic waste is an issue that must be addressed. In particular, the accumulation of waste products at various types of food establishments (e.g. grocery stores, supermarkets, large restaurants, wholesale fruit and vegetable packers, food distributors and the like) has evolved into a considerable waste disposal problem. Such waste consists primarily of spoiled fruits and vegetables, and sometimes the cartons in which such products are shipped.

The accumulation of such waste has historically been collected in dumpsters and transported to various landfills or other suitable disposable areas (e.g. incinerators or the like). Transporting food scraps long distances to landfills contributes enormously to anthropogenic sources of greenhouse gases such as carbon dioxide and nitrogen and sulfur oxides as well as other general air pollutants such as particulate matter, volatile organic compounds, and carbon monoxide. Once land-filled, organic discards such as food scraps contribute to methane production, a greenhouse gas believed to be 20-70 times more effective at trapping heat in Earth's atmosphere than carbon dioxide. While some landfills are collecting the methane gas, most do not; it is simply vented to the atmosphere. In the U.S., this situation is further complicated by the rapidly approaching closure of many landfills.

Transporting food scraps over long distances to incinerators, or waste-to-energy facilities, contribute negatively to the environment. Food scraps have one of the lowest BTU values per pound. Compared to plastics, which range between 11,000 and 20,000 BTUs/lb.; rubber, which produces approximately 11,000 BTUs/lb.; newspaper, which produces 8,000 BTUs/lb.; cardboard, which produces 7,000 BTUs/lb.; food scraps produce only 2,600 BTUs/lb. Consequently, incinerator operators may be forced to supplement their fuel source with fossil fuels to maintain high burning temperatures if too much of their fuel is food scraps.

As landfills are being phased out in many regions and incineration constitutes a source of air pollution, disposal of such waste material is becoming a significant and expensive problem in many cities and communities. Currently there are new regulations in some jurisdictions which prohibit tipping of organics into landfills, and the number of these jurisdictions is expected to rise. Municipal and city governments are focusing efforts on green initiatives as citizens are demanding better solutions for addressing this increasing production of organic waste. However, viable solutions for dealing with this waste are not prevalent.

Currently, in many regions, organic waste processing centers must be located well outside of urban areas due to the required land footprint and the emission of foul odours. This in turn forces organic haulers to travel long distances and burn more fossil fuels in order to deliver the organic waste to these organic processing facilities.

Despite the challenges, there are well known benefits of aerobic digestion of organic waste and to that end, both residential, small scale business and commercial or industrial solutions are developing. Commercial or industrial applications have often focused on outdoor windrowing technology. There are problems associated with this option include odours, limitations on materials to be composted (animal products are often excluded), length of time to produce the compost, and the energy required. Solutions for aerobic in-vessel technology (known by various different names, including rotary drum) are under development in order to overcome the concerns about windrowing. These vessels are contained units, so aerobic in-vessel systems dramatically reduce odour issues; remove limitations about what may be composted (animal products are acceptable), dramatically reduce the time to produce the compost, and require much less energy.

There are a variety of in-vessel composting processes. Such processes enclose the compost in a reactor vessel. They can also mechanize materials handling and mixing of the organic materials to be composted. Vessel systems to date have typically been complicated systems which require precision construction techniques and permanent, stable foundations. Organic waste is typically fed into an opening at one end of the reactor and compost is removed from the other end. The material is moved through the reactor either by a complex moving floor apparatus or by an hydraulic ram. Aeration can be provided by pressurized air forced through the organic waste by air vents located throughout the moving apparatus.

In-vessel reactors at least provide potential for collection of odorous emissions. The compost process can be enclosed and the air routed through a filtration system. Some in-vessel systems also include mixing systems, typically rotating paddles or prongs, within the compost mass. Other in-vessel systems are static. The agitation systems used in in-vessel systems are expensive, prone to wear and failure, and provide agitation only at fixed intervals.

To-date, no processing solution system, particularly in the commercial or industrial space, can operate in an urban setting (thereby reducing transport distance and the associated negative effects) in a cost effective and scalable manner while addressing health, safety, and odour requirements.

It is an object of the present invention to obviate or mitigate the above disadvantages.

### SUMMARY OF THE INVENTION

This invention is directed to a method and apparatus for the processing of organic waste, for example, rotten or wasted fruits and vegetables and the cardboard containers (in which such produce is shipped to various grocery outlets, supermarkets, restaurants and the like) and to use such waste to produce useable compost. The invention comprises all parts of the apparatus and devices and processes necessary to establish a discrete system/facility that can accept organic waste from trucks and process the waste. The invention comprises an apparatus, process and system which can readily be used in an urban setting, with no ill effects due to noxious odours. In this way, the apparatus and system can be used in various urban locations, as needed, to avoid long transportation of organic waste.

The present invention provides, in one aspect, a system for converting organic waste into compost comprising a preliminary storage/pre-processing unit, an auger-free, composting unit comprising a plurality of top entry portals and at least one bottom exit portal, and an organic waste conveyance means between the preliminary storage/pre-processing unit and the auger-free, composting unit. Furthermore, the auger-free composting unit minimally comprises mechanical parts and as such is easy to operate with low maintenance requirements.

The present invention further provides a composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal, wherein each of the plurality of spaced, closable, organic matter waste entry portals are positioned to intermittently and from above receive organic matter waste and wherein the composting chamber comprises a rotating gate at the compost exit portal providing intermittent closing the of the composting chamber and opening of the compositing chamber for transference of compost out of the composting chamber.

The present invention provides, in one aspect, a system for converting organic waste into compost comprising:

a) a hopper for receiving raw organic waste comprising a lid, openable during raw organic waste tipping and closable;
b) an organic waste conveyance means for delivery of the raw organic waste from the hopper to a shredder;
c) a shredder for resizing the raw organic waste to a selected, desired reduced particle size, to form shredded organic waste;
d) an intermediary delivery container for collecting the shredded organic waste;
e) a composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal;
f) a delivery means to align the intermediary delivery container with each of the entry portals on the top surface of the compositing unit;
g) a sealable collection chamber disposed under the composting chamber, aligning with the compost exit portal, said collection chamber comprising at, at least one end thereof, a door for access therein;
h) a collection bin of a size and dimension to fit entirely within the collection chamber and removable therefrom when full of compost;
i) an air supply means for introducing controlled air into the composting chamber to aid in the decomposition of the organic material, comprising blowers and appropriate piping/ducting; and
j) a rotating gate between the compost exit portal and the collection chamber providing intermittent closing the of the composting chamber and opening of the compositing chamber for transference of compost from the composting chamber to the collection bin there below.

The present invention provides, in one aspect, a system for converting organic waste into compost comprising:

a) a hopper for receiving raw organic waste comprising a lid, openable during raw organic waste tipping and closable;
b) an organic waste conveyance means for delivery of the raw organic waste from the hopper to a shredder;
c) a shredder for resizing the raw organic waste to a selected, desired reduced particle size, to form shredded organic waste;
d) an intermediary delivery container for collecting the shredded organic waste;
e) a composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal;
f) a delivery means to align the intermediary delivery container with each of the entry portals on the top surface of the compositing unit;
g) a sealable collection chamber disposed under the composting chamber, aligning with the compost exit portal, said collection chamber comprising at, at least one end thereof, a door for access therein;
h) a collection bin of a size and dimension to fit entirely within the collection chamber and removable therefrom when full of compost;
i) an air supply means for introducing controlled air into the composting chamber to aid in the decomposition of the organic material, comprising blowers and appropriate piping/ducting;
j) a rotating gate between the compost exit portal and the collection chamber providing intermittent closing the of the composting chamber and opening of the compositing chamber for transference of compost from the composting chamber to the collection bin there below; and
k) a biofilter to mitigate odours and emissions from the processing chamber by the air supply system.

The present invention provides, in another aspect, a process of composting organic matter using the system and apparatus of the present invention, as described and claimed herein.

The present invention a provides a process of composting organic matter which comprises

The present system, composting unit and apparatus are simple but function extremely well. Unlike other systems, the system of the present invention does not require a complicated means of trying to ensure even distribution of organic material within a composting chamber, such as augering, moving the chamber around and mixing. Even distribution for processing is readily achieved, at least in part, by the unique placement of the plurality of spaced closable, organic matter waste entry portals at the top of the composting chamber (each intermittently filled at varying times) and in part by the placement of the rotating gate at the bottom of the composting chamber to allow processed material to move vertically (under force of simple gravity) through the chamber and to enable continuous removal of composted material so an appropriate chamber “fullness” is achieved, for optimal processing and steady state composting. Multiple dispersed organic matter waste entry portals at the top of the composting chamber (used as entry points, alternatively) ensure even dispersion of the new material into the chamber. For example, organic matter waste is filled in one entry portal (A) and that entry portal A will preferably not be used as a fill point until at least each of the other entry portals (for example B, C and D) have been used once. Furthermore, in a preferred embodiment, adjacent entry portals may not be filled sequentially but rather A and C, later B and D. As such, the purpose served by mechanical parts such as augers and mixers (which are expensive to service and operate and are prone to malfunction) are totally avoided, within the enclosed composting chamber itself while “gravity” and strategic placement and fill use of input portals and an exit gate are key to even distribution of the material being processed. It has surprising been found that mechanical augering and other pushing means can be avoided by the system of multiple entry portals, selectively used for fill.

The apparatus as provided herein offers significant advantages over previously known and used apparatuses for the above-noted reasons. Furthermore, the apparatus enables the composting of green waste from retail, wholesale food stores at sites which are urban and central to green waste processing needs. This reduces costs and environmental impacts of long-distance green waste haulage and disposal to landfill. The system and apparatus can be operated readily in an urban setting due to the odour and rodent control measures in the design. There are no mixers or augers with the chamber to make noise. The apparatus is highly scalable and each system can be sized to fit the appropriate need and application.

The apparatus produces a valuable compost with possible certification as a higher value fertilizer.

These and other advantages will be full appreciated by the preferred description and figures provided below.

### BRIEF DESCRIPTION OF THE DRAWINGS

FIG. 1 is a side view of an intake unit for raw organic matter;

FIG. 2 is a top view of an intake unit for raw organic matter;

FIG. 3 is a side view of a composting unit comprising an enclosable composting chamber;

FIG. 4 is an end view of a composting unit comprising an enclosable composting chamber; and

FIG. 5 is a schematic, in perspective view, of the entire processing system of the invention

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The invention is susceptible to many variations, including scaling for capacity, in so long as process parameters are maintained. Accordingly, the drawings and following description of the preferred embodiment are to be regarded as illustrative in nature, and not as restrictive.

### 1. Terms

The term “product” means any machine, manufacture and/or composition of matter, unless expressly specified otherwise.

The term “apparatus” means the organic matter processing system in accordance with the present invention.

The term “method” or “process” means any process, method or the like, of using the apparatus of the invention, unless expressly specified otherwise.

Each process (whether called a method or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” or “variant” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn.1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

### II Overview

The invention provides for an aerobic in-vessel digestion system particularly suited to the accelerated digestion of organic waste material from commercial operations such as, for example, restaurants, institutions (schools, hospitals) food stores and the like. This invention provides several advantages over prior solutions. The composting system is capable of operating efficiently and with minimal preventative maintenance and is designed to minimize potential malfunctions by reducing the number of moving parts (particularly enclosed moving parts, which are more costly to service).

The invention comprises an apparatus and process and system essentially used for the production of compost from organic waste material. Micro-organisms, such as bacteria, mold fungi, protozoa, nematodes or actinomycetes participate in the composting process, and the aerobic decomposition produces a highly usable compost material.

Decomposition or rotting depends essentially on the oxygen content, water content, C/N nutrient content, temperature and pH of the material to be converted. With a sufficient air supply, this process proceeds virtually without odors, in particular, at temperatures of 60° to 90° on average.

The present invention provides an apparatus in which optimal operation within the composting chamber is best at or near full. There is no turning or mixing or complex parts required to achieve such turning and mixing. No augers or mixers are necessary in the actual composting chamber. One key aspect of the invention is that a mass of organic material (shredded from pre-processing) is simply fed into the chamber via a plurality of spaced/interspersed top entry portals. Feeding at each portal is preferably alternating (at intervals) so the mass of shredded organic material is interspersed substantially equally across the chamber. By gravity and aerobic processing, along with the removal of fully processed material from the bottom of the chamber, mass moves from the top to bottom of the chamber naturally and in a vertically more consistent and uniform manner due to the multiple entry portals.

The present invention provides a sealed composting chamber which is aerated. Aeration accelerates drying. Bacteria used in composting process create heat which further accelerates drying under these closed, controlled conditions. One key operational aspect, which the design of the present apparatus achieves well, is the maintenance of aerobic conditions (balance of oxygen, heat and bacteria viability). Processed organic material, within the enclosed composting chamber, “sinks” from the spaced-apart top entry portals. Newly in-fed organic material sits at the top, above the more advanced processed material. The apparatus reduces volume of organic material under aerobic conditions (hence, no smell, a reduction in pests and animals, etc. . . . ).

The present invention provides, in one aspect, a system for converting organic waste into compost comprising:

a) a hopper for receiving raw organic waste comprising a lid, openable during raw organic waste tipping and closable;
b) an organic waste conveyance means for delivery of the raw organic waste from the hopper to a shredder;
c) a shredder for resizing the raw organic waste to a selected, desired reduced particle size, to form shredded organic waste;
d) an intermediary delivery container for collecting the shredded organic waste;
e) a composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal;
f) a delivery means to align the intermediary delivery container with each of the entry portals on the top surface of the compositing unit;
g) a sealable collection chamber disposed under the composting chamber, aligning with the compost exit portal, said collection chamber comprising at, at least one end thereof, a door for access therein;
h) a collection bin of a size and dimension to fit entirely within the collection chamber and removable therefrom when full of compost;
i) an air supply means for introducing controlled air into the composting chamber to aid in the decomposition of the organic material, comprising blowers and appropriate piping/ducting;
j) a rotating gate between the compost exit portal and the collection chamber providing intermittent closing the of the composting chamber and opening of the compositing chamber for transference of compost from the composting chamber to the collection bin there below; and
k) a biofilter to mitigate odours and emissions from the processing chamber by the air supply system.

More specifically, the enclosable composting chamber comprises a top, a bottom, a first end, a second end and two opposing sides. The composting chamber comprises, on its top surface, a plurality of spaced closable, organic matter waste entry portals and also comprises, at the bottom of the composting chamber, at least one compost exit portal. The spaced closable, organic matter waste entry portals are removably matable with a delivery vehicle or delivery container for the transfer of shredded organic waste therethrough and into said chamber. The compost exit portal is aligned with a sealable collection chamber disposed under the composting chamber, and the compost exit portal comprises a rotating gate enabling intermittent closing of the composting chamber and opening of the compositing chamber for transference of compost from the composting chamber to the collection chamber there below.

Preferably, the hopper for receiving raw organic waste comprises an opening at or near ground level for receiving raw organic matter from a transport means, such as a truck. In another aspect, a ramp is aligned with an opening of the hopper such that a truck or transport means carrying the raw organize waste simply drives up the ramp to more easily deposit the load into the open hopper. In one aspect, a hopper pit is below ground level.

Preferably, an organic waste conveyance means delivers the raw organic waste from the hopper to a shredder or chipper, adjacent to the hopper. All new organic material is fed through this shredder or chipper prior to feeding into the composting chamber so that surface area of particulates is increased for drying. Most preferably, the raw organic waste is shredded into a particle size no larger than one cubic inch. Preferably, the shredder is a material shredder/particle size reducer powered by a electric motor that provides low speed, high torque counter-rotating cutters that intensively shear and shred. The tooth size, blade size, and spacing of the shredder are calculated to tear and shred the supplied raw organic matter into particles not larger than 1 cubic inch. The shredder is capable of handling the all food scraps, including bones, as well as supplemental bulk materials. Preferred conveyance means to the shredder, from the hopper, include augers and conveyer belts.

After shredding of the raw organic material or feedstock to the optimal size, it is required to convey it to at least one entry port within the compost chamber for subsequent aerobic digestion within the chamber, then off-loading through the bottom exit portal. The high internal temperatures inside of the chamber generally vaporize water in the organic matter that is exhausted via a combination of enforced aeration and an exhaust vent. The system of the invention enables continuous input of feedstock, at alternating entry ports at the top of the chamber. Preferably, there is provided in alignment with the shredder, a tote dock, into which the tote is engaged during filling of the shredded organic matter from the shredder.

Another key aspect of the invention is the provision of a delivery means to align the intermediary delivery container with each of the entry portals on the top surface of the compositing unit. In one aspect, this may be achieved by use of a container or “tote” for collecting the shredded organic waste and then transferring the organic waste to one of the selected entry portals. It is to be understood that the tote collection and transfer to the selected portal may be fully automated as long as after filling of the tote, alternating portals are used for entry and conveyance of material into the chamber. However, within the present invention, the delivery means to align the intermediary delivery container with the docking stations at the entry portals on the top surface of the compositing unit may be achieved by other means including conveyer belts/assemblies and chutes (with conveyance by gravity or by mechanical means). If totes or containers are used, they may be moved by hydraulic lifts, forklifts or other appropriate material transfer devices, apparatus and machines.

In one aspect of the invention, the rotating gate comprises a sensor for tallying the number of open-shut gate rotations and there is a means to feedback the tally to a controller, said controller controlling organic matter feed intake at the organic matter entry port. The controller may additionally and preferably provide automatic feedback to the delivery means, such that a “reaction-conditions optimal” amount of organic waste is delivered to a desired entry portal, at a desired time in order to maintain optimal biochemical processing conditions.

Preferably, the composting unit comprising an enclosable composting chamber with a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal. Within the context of the invention, multiple or plurality of entry portals preferably means greater than two. There may be three entry portals. There may be four entry portals. The specific number of portals depends of on the size the of entire chamber. In a preferred aspect, each portal is equally dispersed from all others. In one aspect of the invention, the portals are staggered i.e. not in alignment across the top of the chamber. The composting chamber is preferably fabricated of stainless steel although it could be made of any suitable material which does not adversely affect the composting process.

In a preferred aspect, there is provided a tote docking station above each entry port on the chamber, such station being engagable with the tote and to secure tote in position during emptying of contents into the chamber, via the entry port. In a preferred aspect the tote is filled through an open top while in position in the tote dock, under the shredder. The tote is then conveyed into a position of removable engagement with a tote docking station at which time either a bottom door of the tote opens or an aperture within the bottom surface of the tote opens to release contents into the chamber. It is optional that the top of the tote comprises a lid.

Particle size is an important aspect of the composting process. If the waste particles are too large, the relatively small ratio of surface area to mass inhibits the start of the process. Shredding the material prior to input in the composting chamber offers a large advantage in this respect. On the other hand, if the input material is shred too small, porosity and the ability of the material to be aerated is greatly diminished. As a result, bacteria is less able to act. An optimal particle size may be considered to be about 3 cubic inches. A shredder in the infeed stage provides for this requirement.

Preferably, the shredder reduces the material into particles of not more than one by one by three inches, the maximum size calculated to facilitate efficient and complete composting in accordance with the process and apparatus of the invention. Particles larger than about four cubic inches (while workable) begin to reduce the speed and effectiveness of the bacterial action. Smaller is generally better.

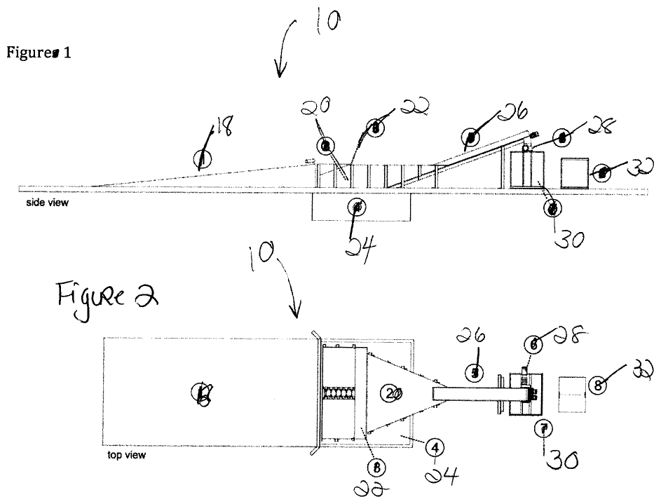

Turning now to the drawings, wherein like numbers denote like parts throughout the several views, FIGS. 1-5 are illustrative views of an apparatus consistent with various embodiments of the invention. There is provided FIG. 1 a side view of a intake system 10 showing the entire intake unit for raw organic matter, comprising a hopper 20 for receiving raw organic waste comprising a lid 22, openable during raw organic waste tipping and closable; an organic waste conveyance means 26 for delivery of the raw organic waste from the hopper 20 to a shredder 28; and shredder 28 for resizing the raw organic waste to a selected, desired reduced particle size, to form shredded organic waste.

There is provided FIG. 2 a top view of system 10.

Legend for FIGS. 1 and 2 is as follows:
1) Truck ramp—18
2) Main hopper—20
3) Hopper lid—22
4) Hopper pit—24
5) Conveyor or auger with motors 26
6) Shredder—28
7) Transfer tote dock—30
8) Transfer tote—32

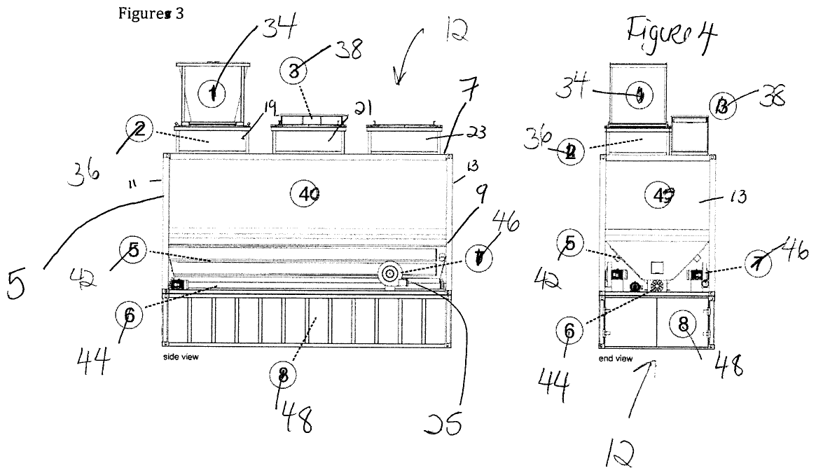

FIGS. 3 and 4 illustrate the composting unit of the invention (generally indicated at 12) comprising an enclosable composting chamber 5 comprising a top 7, a bottom 9, a first end 11, a second end 13 and two opposing sides 15 and 17, wherein the composting chamber comprises, on its top surface, a plurality of spaced, closable, organic matter waste entry portals 19, 21 and 23 (collectively referred to as 36) and also comprises, at the bottom 9 of the composting chamber 5, at least one compost exit portal 25 comprising exit flipper 44; a delivery means (such as forklift 66) to align the intermediary delivery container or tote 34 with each of the entry portals 19, 21 and 23 on the top surface of the compositing unit; a sealable collection chamber (or collection hopper) 48 disposed under the composting chamber, aligning with the compost exit portal, said collection chamber or hopper 48 comprising at, at least one end thereof, a door for access therein; a collection bin of a size and dimension to fit entirely within the collection chamber and removable therefrom when full of compost; an air supply means (for example air blowers 46) for introducing controlled air into the composting chamber to aid in the decomposition of the organic material, comprising blowers and appropriate piping/ducting; a rotating gate between the compost exit portal and the collection chamber providing intermittent closing the of the composting chamber and opening of the compositing chamber for transference of compost from the composting chamber to the collection bin there below

Legend for FIGS. 3 and 4 is as follows:
1) Transfer tote—34
2) Tote docking and waste entry port—36
3) Biofilter—38
4) Primary processing chamber—40
5) Aeration ducting—42
6) Exit flipper—44
7) Air blowers—46
8) Exit hopper—48

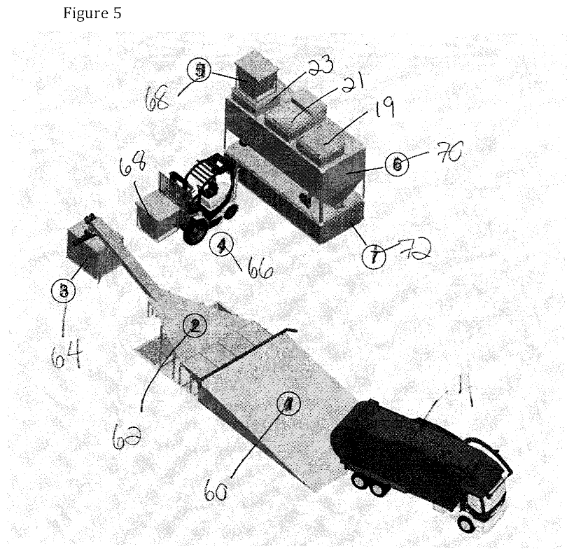

FIG. 5 illustrates a perspective view of the entire processing system of the invention, in operation, from above. In this figure, tote transfer unit 68 is sitting atop of organic matter waste entry portal 23 ready to dispesne the shredded raw organic material into the composting chamber (also known herein as processing unit 70 or Primary processing chamber-40—all are the same unit). In this operation, forklift 66 is the delivery means employed to align the intermediary delivery container 68 or tote 34 (both refer to same item) with each of the entry portals 19, 21 and 23 on the top surface of the composting chamber (also known herein as processing unit 70 or Primary processing chamber-40)

Legend for FIG. 5 is as follows:

### Processing Unit Diagrams

1) Truck ramp-60
2) Intake hopper-62
3) Transfer tote dock-64
4) Forklift moving transfer tote-66
5) Transfer tote delivery waste to processing unit-68
6) Processing unit-70
7) Exit hopper-72

Preferred aspects of the operation of the system of the invention are as follows:
1. Organic (raw) waste is trucked to a site housing the system and the contents unloaded into a hopper. Preferably in one aspect, a truck backs up a ramp, at an incline and deposits load of raw organic waste into a near ground-level hopper opening.
2. An organic waste conveyor delivers the raw organic waste from the hopper to a shredder/chipper A chipper preferably comprises knife blades mounted on a rapidly rotating disk. Preferably, organic waste is chipped to a nominal (for example, 1″ (2.5 cm)) particle size and is projected into a tote, sitting in a tote dock, by the chipper.
3. A tote, comprising shredded organic waste, is weighed and then moved by a hydraulic lift into a secure but removable position on a tote docking station, on one (of the multiple) entry portals at the top of the chamber.
4. Over a period of time of up to about 2 minutes, the contents of the tote are emptied into the compositing unit/chamber. Preferably, on a timed basis, the bottom of the tote closes, and the hydraulic lift lowers the tote back onto the tote dock under the shredder where it is weighed and recorded. Steps 2, 3 and 4 are repeated. The total weight of loaded organic “green” waste can be compared to the dried and composted green waste in the collection bin.
5. The apparatus is operated (preferably and optimally) at a level which is at least 90% full. In one aspect, a light sensor across the width of the composting unit/chamber near the freshly chipped green (organic) waste detects when the composting chamber is full.
6. In a preferred aspect, two blowers continuously inject air up through the bed of the composting unit/chamber. Air is vented out of the top of the composting unit/chamber. The maximum rate of air flow is limited by the availability of single phase electricity to power the blower, nominally 5 hp.
7. Activated by a light sensor, a rotary 4 paddle gate at the bottom of the chamber rotates in 90° increments (to minimize intrusion of rats into the composting chamber) until the light sensor at the top of the composting chamber detects that there is again room for more green waste adjacent to the chipper.
8. A counter on the rotary gate indicates the number of gate rotations and hence the amount of composted and dried green waste that should have dropped into the underlying 20′×6′×4′ (18 m3 or 640 ft3) height roll-off collection bin, within the collection chamber. The counter may be calibrated to read “% Full” so a user knows when to replace the collection bin. In one aspect, a maximum weight of material in the collection bin is 6 tones. This is of course variable depending on the size of the collection bin.
9. When the collection bin is full of dried and composted green waste (the compost), the collection chamber door or doors are opened and the bin is removed from the length of apparatus and is hauled away. A new collection bin is pushed under the apparatus, within the collection chamber to again collect dried and composted waste, enabling a continually operating process.

The collection bin is housed in a sealed collection chamber, in part, so rats and other pests cannot feed at the collection bin. When the collection bin is to be changed out, end doors are opened. When the collection bin is replaced, the end doors are closed.

### Process:

The present invention provides a process for composting organic material comprising the steps of:

(a) shredding raw organic material a selected, desired reduced particle size, to form shredded organic waste;
(b) delivering shredded raw organic waste to a first entry portal at the top of a composting unit, wherein said composting unit comprises a composting chamber with a plurality of spaced, closable, organic matter waste entry portals on its top surface and also comprises, at the bottom of the composting chamber, at least one compost exit portal;
(c) incubating the shredded raw organic waste within the composting chamber until shredded raw organic waste is composted and by gravity falls to the bottom of the composting chamber;
(d) as needed to maintain composting chamber at or near full for optimal composting, delivering further shredded raw organic waste to a second entry portal on the top of the composting chamber;
(e) as needed to maintain composting chamber at or near full for optimal composting, delivering further shredded raw organic waste to a second entry portal on the top of the composting chamber;
(f) collecting gravity moved processed compost from compost exit portal.

In a preferred aspect, the process additionally provides the step of sensoring monitoring fill level of composting chamber to ensure operation at or near full and to trigger further fill at one or more of one entry portal at the top of a composting chamber.

In a preferred aspect, the process additionally provides the step of sensoring order of fill of each entry portal at the top of a composting chamber to ensure that composting chamber is uniformly filled across top.

In a preferred aspect, as needed to maintain composting chamber at or near full for optimal composting, the process provides for delivering further shredded raw organic waste to a third entry portal on the top of the composting chamber.

In a preferred aspect, as needed to maintain composting chamber at or near full for optimal composting, the process provides for delivering further shredded raw organic waste to a fourth entry portal on the top of the composting chamber.

In a preferred aspect, as needed to maintain composting chamber at or near full for optimal composting, the process provides for delivering further shredded raw organic waste to a additional entry portals on the top of the composting chamber.

In one aspect, no two adjacent entry portals on the top of the composting chamber are sequentially filled in order to ensure a uniform fill level of shredded raw organic waste across the top interior of the composting chamber.

In one aspect, a sensor directs and operates the opening of rotary exit gate at the bottom of the composting chamber.

In one aspect, shredded raw organic waste is delivered to each entry portal at the top of a composting unit by a conveyancing means, which is positionable and alignable with each entry portal. In one embodiment, this may be achieved by a delivery means aligning an intermediary delivery container or tote with an entry portal on the top surface of the compositing unit. This alignment is generally with one entry portal at a time although in some circumstances, for optimal fill efficiency, such alignment may be with two or more entry portals at a time.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various devices and methods described above may omit some parts or acts, include other parts or acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A system for converting organic waste into compost comprising:
a) a hopper for receiving raw organic waste comprising a lid, openable during raw organic waste tipping and closable;
b) an organic waste conveyance means for delivery of the raw organic waste from the hopper to a shredder;
c) a shredder for resizing the raw organic waste to a selected, desired reduced particle size, to form shredded organic waste;
d) an intermediary delivery container for collecting the shredded organic waste;
e) a composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal;
f) a delivery means to align the intermediary delivery container with each of the entry portals on the top surface of the compositing unit;
g) a sealable collection chamber disposed under the composting chamber, aligning with the compost exit portal, said collection chamber comprising at, at least one end thereof, a door for access therein;
h) a collection bin of a size and dimension to fit entirely within the collection chamber and removable therefrom when full of compost;
i) an air supply means for introducing controlled air into the composting chamber to aid in the decomposition of the organic material, comprising blowers and appropriate piping/ducting;
j) a rotating gate between the compost exit portal and the collection chamber providing intermittent closing the of the composting chamber and opening of the compositing chamber for transference of compost from the composting chamber to the collection bin there below; and
k) a biofilter to mitigate odours and emissions from the processing chamber by the air supply system.

2. The apparatus of claim 1 wherein the composting chamber is substantially rectangular.

3. The apparatus of claim 1 wherein the composting chamber comprises a V-shaped bottom.

4. The apparatus of claim 1 wherein the collection chamber comprises additional service doors.

5. The apparatus of claim 1 wherein the rotating gate is activated by a sensor.

6. The apparatus of claim 1 wherein the rotating gate opens and closes in 90 degree increments.

7. The apparatus of claim 1 wherein the rotating gate comprises a sensor for tallying the number of open-shut gate rotations.

8. The apparatus of claim 1 wherein the rotating gate comprises a sensor for tallying the number of open-shut gate rotations and there is a means to feedback the tally to a controller, said controller controlling organic matter feed intake at the organic matter entry port.

9. The apparatus of claim 1 wherein the air supply means comprises two air inlets disposed to inject air through the bottom of the composting chamber to the top of the composting chamber.

10. The apparatus of claim 1 wherein the auger is disposed to draw organic matter down a length of the composting chamber and to prevent clogging of the organic matter at the organic matter entry portal.

11. The apparatus of claim 1 wherein the composting chamber comprises a volume sensor enabled to feedback data to a controller, therein to ensure that the composting chamber is always at least 90% full of organic matter.

12. The apparatus of claim 11 wherein the sensor is a light sensor across a width of the composting chamber, adjacent to the top.

13. The apparatus of claim 1 wherein shredder comprises a multi-toothed rotary shredding mechanism configured to produce shreds about one inch by one inch by four inches in size.

14. A process of composting organic matter using the apparatus of claim 1.

15. A process for composting organic material comprising the steps of:
(a) shredding raw organic material a selected, desired reduced particle size, to form shredded organic waste;
(b) delivering shredded raw organic waste to a first entry portal at the top of a composting unit, wherein said composting unit comprises a composting chamber with a plurality of spaced, closable, organic matter waste entry portals on its top surface and also comprises, at the bottom of the composting chamber, at least one compost exit portal;
(c) incubating the shredded raw organic waste within the composting chamber until shredded raw organic waste is composted and by gravity falls to the bottom of the composting chamber;
(d) as needed to maintain composting chamber at or near full for optimal composting, delivering further shredded raw organic waste to a second entry portal on the top of the composting chamber;
(e) as needed to maintain composting chamber at or near full for optimal composting, delivering further shredded raw organic waste to a second entry portal on the top of the composting chamber;
(f) collecting gravity moved processed compost from compost exit portal.

16. The process of claim 15 additionally providing the step of sensoring monitoring fill level of composting chamber to ensure operation at or near full and to trigger further fill at one or more of one entry portal at the top of a composting chamber.

17. The process of claim 15 additionally providing the step of sensoring order of fill of each entry portal at the top of a composting chamber to ensure that composting chamber is uniformly filled across top.

18. The process of claim 15 wherein, as needed to maintain composting chamber at or near full for optimal composting, delivering further shredded raw organic waste to a third entry portal on the top of the composting chamber.

19. The process of claim 15 wherein as needed to maintain composting chamber at or near full for optimal composting, delivering further shredded raw organic waste to a fourth entry portal on the top of the composting chamber.

20. The process of claim 15 wherein as needed to maintain composting chamber at or near full for optimal composting, delivering further shredded raw organic waste to additional entry portals on the top of the composting chamber.

21. The process of claim 15 wherein no two adjacent entry portals on the top of the composting chamber are sequentially filled.

22. The process of claim 15 wherein shredded raw organic waste is delivered to each entry portal at the top of a composting unit by a conveyancing means, which is positionable and alignable with each entry portal.

23. A composting unit comprising an enclosable composting chamber comprising a top, a bottom, a first end, a second end and two opposing sides, wherein the composting chamber comprises, on its top surface, a plurality of spaced, closable, organic matter waste entry portals and also comprises, at the bottom of the composting chamber, at least one compost exit portal, wherein each of the plurality of spaced, closable, organic matter waste entry portals are positioned to intermittently and from above receive organic matter waste and wherein the composting chamber comprises a rotating gate at the compost exit portal providing intermittent closing the of the composting chamber and opening of the compositing chamber for transference of compost out of the composting chamber.
